(19) United States
(12) Patent Application Publication
(10) Pub. No.: US 2026/0285587 A1
(43) Pub. Date: Sep. 24, 2026

(54) CONTAINER PROVIDED WITH SEALING MEMBER FOR DOOR

(71) Applicant: KDU CO., LTD., Busan (KR)

(72) Inventor: Soon Wook KWON, Busan (KR)

(73) Assignee: KDU CO., LTD., Busan (KR)

(21) Appl. No.: 19/570,636

(22) Filed: Mar. 18, 2026

(30) Foreign Application Priority Data
Mar. 20, 2025 (KR) 10-2025-0035883

(51) Int. Cl. B65D 90/00; F16J 15/3284

(52) U.S. Cl. CPC B65D 90/008; F16J 15/3284; B65D 2590/542

(57) ABSTRACT

An airtight structure for a container door, including: a rear frame provided at a rear of a container body; a door mounted on the rear of the container; and a door sealing member (300) provided between the rear frame and the door to seal the inside of the container. The door sealing member includes: a first sealing member (310) mounted on the door and made of a rubber material; a second sealing member (320) made of a rubber material softer than the first sealing member, formed in a semi-circular shape protruding upward from an upper surface of the first sealing member, and configured to contact the rear frame; and an L-shaped retainer (350) attached to the upper surface of the first sealing member. The airtight door structure using the door sealing member blocks the inflow of external air into the container, preventing the internal humidity of the container from rising.

### TECHNICAL FIELD

The present invention relates to a sealing structure for a container door unit, and more particularly, to a door sealing structure for a container configured to prevent external air from inflowing through a gap in the container door and to maintain the humidity inside the container at or below a predetermined level in a non-powered manner without a separate power source. Field

### BACKGROUND ART

Generally, a container accommodates and transports various types of cargo inside. Large cargo that is difficult to accommodate inside a container, or cargo that requires refrigerated or frozen transport, is subject to special packaging, and a number of special containers have been developed and used for this purpose.

For example, in the case of large cargo that is difficult to fit inside a container, special packaging is performed using a Flat Rack container with the ceiling and side walls removed or an Open Top container with an open ceiling.

In the case of frozen or refrigerated cargo, transport is carried out through a Reefer Container equipped with an insulated internal space and a refrigerator, and the transfer operation is carried out with the power connected to maintain the cold air.

On the other hand, the transport of general cargo, excluding the special containers mentioned above, is mainly performed by general containers called Dry Containers.

The dry container is a welding-steel structure in which each part forming the internal space is individually configured in the form of an assembly, and is configured to have structural strength and protection against corrosion and external impact.

Wooden floors are generally applied to the floors of the dry containers because wood has good elasticity, is easy to repair, and allows cargo to be easily fixed by nailing into the wood in preparation for cases where cargo of various shapes is accommodated.

However, in the case of a wooden floor, when thick iron nails embedded in the wood are removed after transporting cargo, large nail holes are created in the floor, through which external air can flow in. Furthermore, as the wood absorbs and then re-releases moisture, the cargo accommodated inside is easily exposed to humidity, leading to cargo damage.

Meanwhile, in order to solve the problems of wooden floors, such as defects like breakage due to low strength, technologies for configuring container floors with steel floors have been developed.

For example, in the case of large cargo that is difficult to accommodate inside a container, special packaging is performed using a Flat Rack container with the ceiling and side walls removed or an Open Top container with an open ceiling.

In addition, in the case of frozen or refrigerated cargo, transport is carried out through a Reefer Container equipped with an insulated internal space and a refrigeration unit, and the transfer operation is performed while power is connected to maintain cold air.

On the other hand, the transport of general cargo, excluding the aforementioned special containers, is mainly performed by general containers referred to as Dry Containers.

The dry container is a welding-steel structure in which each part forming the internal space is individually configured in an assembly form, and is configured to provide structural strength and protection against corrosion and external impact.

Wooden floors are applied to the floors of the dry containers because wood has good elasticity and is easy to repair, and cargo can be easily fixed by nailing into the wood to prepare for cases where cargo of various shapes is accommodated.

However, in the case of a wooden floor, when thick iron nails embedded in the wood are removed after transporting cargo, large nail holes are created in the floor, through which external air can flow in. Furthermore, as the wood absorbs and then re-releases moisture, the cargo accommodated inside is easily exposed to humidity, leading to cargo damage.

Meanwhile, in order to solve the problems of wooden floors, such as defects like damage due to low strength, technologies for configuring container floors with steel floors have been developed.

European Patent (EP3642064B1) includes a container refrigeration unit (specifically, a Curtain Track Sealing Adapter) to maintain airtightness inside the container. This is a device designed to maintain airtightness to prevent leakage when nitrogen gas is injected to keep vegetables inside the container fresh. Injecting nitrogen gas has the effect of extending the storage period by 3 to 4 times by causing fruits or vegetables to stop breathing. The purpose of this invention is to prevent nitrogen gas from leaking to the outside; however, to prevent the leakage of nitrogen gas from inside the container, not only is a separate installation process for the curtain track unit required at the cargo loading site, but there is also the inconvenience of having to insert vinyl using a separate tool to complete the sealing work. The aforementioned European patent relates to separate sealing units (track, vinyl curtain, and a tool for inserting the vinyl curtain), and the requirement to use a separate tool causes inconvenience in use.

Therefore, there was a need for container manufacturing technology that maintains container airtightness without requiring additional work, and for container technology that completes the sealing process simply by closing the door with an airtight function in the door unit.

Among the world's container cargo volume, dry containers transported by sea for long periods account for an overwhelmingly high proportion. However, due to their structure, 100% perfect sealing cannot be achieved, leading to a condensation phenomenon known as "container rain" on the inner walls of the container and the cargo, which causes fatal damage such as mold, corrosion, oxidation, and warping to the loaded cargo.

In particular, expensive mechanical equipment made of metal, iron, processed goods, and other iron raw materials are accommodated in standardized dry containers for import and export. Since such cargo has a relatively lower surface temperature than the air temperature inside the container due to its relatively high heat capacity, there is a very high possibility of direct condensation occurring on the cargo surface. Furthermore, if air containing salt causes surface condensation during maritime transport, the possibility of oxidation or corrosion of the cargo increases further.

Therefore, to prevent the occurrence of such condensation, logistics sites employ one or more combined packaging methods, such as vacuum packaging of the product itself, anti-corrosion coating, and the insertion of preservatives to prevent mold.

However, anti-corrosion coating has the problem of requiring an additional process to remove the coating layer after transportation is completed, and inserting preservatives does not serve as a fundamental countermeasure against condensation. Furthermore, the resulting costs for packaging and dismantling are ultimately passed on to the final consumer, creating a practical problem of increasing the price of purchased goods.

In addition, various types of structures are used to maintain the airtightness of the container door unit. However, since containers are used under very harsh conditions and generally for around 15 years, corrosion occurs in the door unit, and various damages arise due to the impact of extreme operations. As a result, the existing structures for sealing the container door are compromised, preventing airtightness from being fully maintained even when the door is closed. Furthermore, the door unit frame is generally painted to prevent corrosion, but during long-term use of the container, the surface becomes rough due to paint peeling and the like. This leads to poor contact with the rubber materials installed for sealing the door unit, making it difficult to maintain airtightness. Consequently, the internal airtightness of the container is lost, still leading to problems such as mold growth due to moisture absorption by the internal cargo or corrosion of metal products.

### SUMMARY

The object of the present invention is to provide a dehumidifying container structure that prevents internal condensation by blocking air inflowing from the outside of a container into the internal space through a door gap, thereby ensuring sealing performance of the internal space of the container and maintaining the internal humidity at or below a predetermined level in a non-powered manner.

Another object of the present invention is to provide a container door structure that prevents the inflow of external air by improving and sealing the door structure in order to maintain the humidity inside the container.

The present invention relates to a sealing structure for a container door unit, comprising: a rear frame provided at a rear surface of a container body; a door mounted on the rear surface of the container to open and close the inside and outside; and a door sealing member (300) provided between the rear frame and the door to seal the inside of the container,

wherein the door sealing member includes: a first sealing member (310) mounted on the door and made of a rubber material; a second sealing member (320) made of a rubber material softer than the first sealing member, formed in a semi-circular shape protruding upward from an upper surface of the first sealing member, and configured to contact the rear frame; and an L-shaped retainer (350) attached to the upper surface of the first sealing member.

The first sealing member (310) comprises: a 1-1 member (312) coupled to one surface of the door in a lateral direction; a 1-2 member (314) formed in a vertical direction at one lateral end of the 1-1 member; and a 1-3 member (316) formed to protrude vertically upward from the center of the upper surface of the 1-1 member.

The retainer (350) comprises: a horizontal member (352) positioned on the upper surface of the 1-1 member; and a vertical member (354) formed in a vertical direction at one end of the horizontal member.

The device further comprises: a core member (340) provided along a lateral direction inside the 1-1 member (312); a bolt (360) passing through and fastening the horizontal member of the retainer, the 1-1 member, and the core member to couple the first sealing member to the door; and a nut (365) fastened to an upper end of the bolt.

In the process of closing the door, a side surface of the rear frame comes into contact with an inner vertical surface of the 1-2 member (314), and a lower surface of the rear frame comes into contact with upper ends of the 1-3 member (316) and the second sealing member (320), thereby maintaining the inside of the container in an airtight state.

As described above, the present invention achieves the advantageous effect of blocking the inflow of external air into the container through the airtight door structure using the dual-rubber door sealing member, thereby preventing the internal humidity of the container from rising and enabling the maintenance of humidity at a predetermined level.

In particular, due to the dual-rubber structure of the present invention, the relatively hard first sealing member is primarily and firmly coupled to the door to protect the relatively soft second sealing member. Even if partial damage occurs on the surface of the door unit during repeated opening and closing processes, the structure of the second sealing member allows for surface contact, thereby very effectively performing the internal sealing function of the container despite paint damage or partial surface damage to the door unit

### BRIEF DESCRIPTION OF THE DRAWINGS

FIG. 1 is an overall view of a container according to the present invention;

FIG. 2 is a longitudinal sectional view of a container according to the present invention;

FIGS. 3A and 3B are views showing a door sealing member according to the present invention;

FIGS. 4A and 4B are views showing the door sealing member of FIGS. 3A and 3B mounted on a container according to the present invention;

FIG. 5 conceptually shows a state in which a door is closed in the container of the present invention; and

FIG. 6 shows a door sealing member according to another embodiment of the present invention.

### DETAILED DESCRIPTION

The container according to the present invention uses steel members throughout its floor structure instead of conventional wood. That is, the container floor of the present invention consists of a steel base structure having a bent shape and is formed of a single steel plate as a whole, thereby blocking the inflow of external air through the floor to provide an internal space with secured airtightness. Through this, moisture inflow caused by external air ingress is prevented, allowing the internal humidity of the container to be maintained at or below a predetermined level. Although not shown, to seal the inside of the container, the rear door that performs the opening and closing operations is provided with a sealing member along its edge, or an air curtain is used to completely block the inflow of air through the door edge when the door is closed.

In addition, to maintain the pressure of the internal space of the container, an inflow path for external air entering the container is separately formed. The most significant feature of the present invention is that it includes a dehumidifying means for removing moisture contained in the external air flowing through this inflow path, thereby enabling the inside of the container to always maintain humidity at or below a predetermined level without a separate power supply.

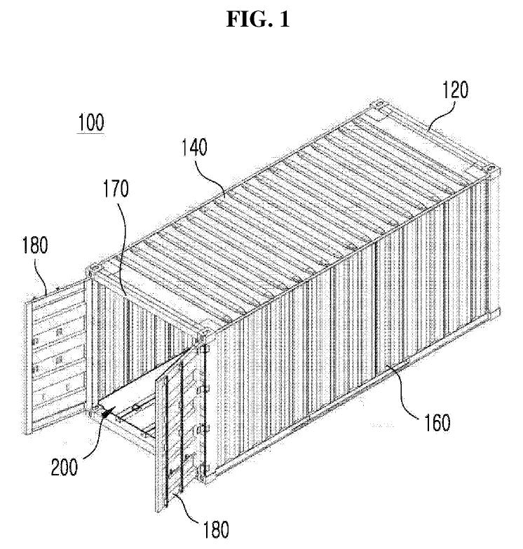

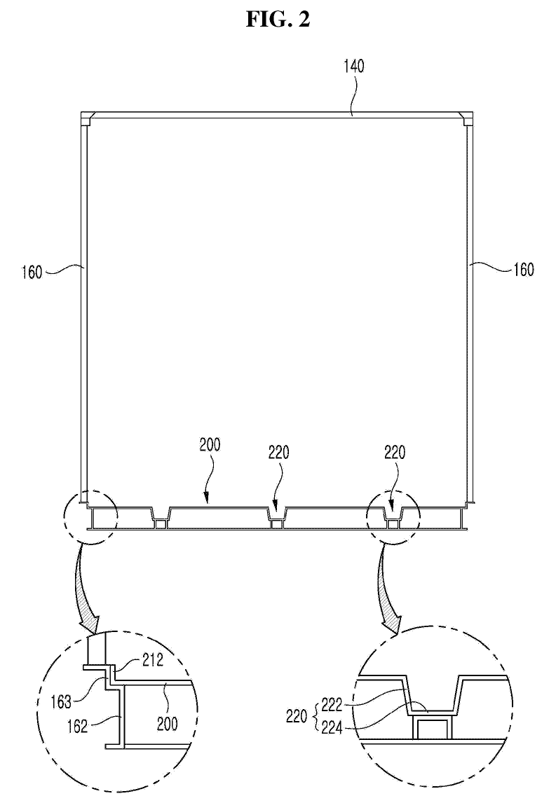

FIG. 1 is an overall view of a container according to the present invention, and FIG. 2 is a longitudinal sectional view of the container of the present invention, showing a cross-sectional view of a structure in which the bottom floor is made of a steel base to enable internal sealing of the container.

Referring to these drawings, in the container (100) according to the present invention, a front surface (120), an upper surface (140), and both side surfaces (160) are formed of metal steel plates, and a rear surface is formed to be openable and closable by a door (180). In addition, the bottom floor of the container is formed of a steel material, specifically a steel base having bent portions (hereinafter referred to as a "steel base (200)"), to block the inflow of air through the internal floor. The container of the present invention has a structure in which the entirety is sealed because there are no passages for air to flow in through the upper surface, lower surface, and side walls. In the drawings, 170 denotes a frame member located at the rear of the container body, which is a rectangular frame portion of the container body that faces the door (180) when it is closed; in the following description, it is referred to as a "rear frame" for convenience.

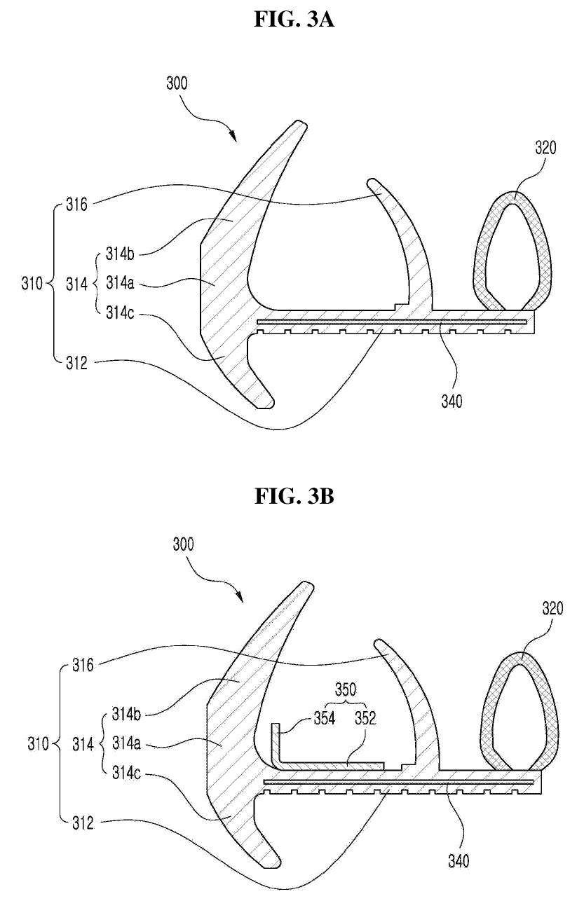

The present invention is to ensure internal airtightness by improving the container door structure so that the internal space of the container is sealed from external air when the door (180) is closed (as described below with reference to FIG. 3A). In addition, the steel base of the lower floor of the container has a structure in which corrugated steel plates of a certain width are welded at the sides, so that the internal space is entirely sealed.

The metal steel plates forming the front surface (120), upper surface (140), and both side surfaces (160) that constitute the internal space are each welded to the framework and integrated, and the lower portions of both side surfaces (160) are coupled to each other using the edges and bent portions of the steel base (200).

To this end, side beams (162) are located at the lower portions of both side surfaces (160), and the side beams (162) are bent to have a stepped portion (163) at the upper side. In addition, a joint end (212) bent for jointing is provided at the side end portion of the steel base (200). The lower ends of both side surfaces (160) and the joint end (212) of the steel base (200) seated on the stepped portion (163) are welded together and integrated, and as a result, the inflow of external air through the edges of the steel base (200) can be prevented.

The steel base (200) according to the present invention does not form holes such as for nails or rivets through which external air can communicate, and is integrally formed by welding using the stepped portion (163) and the joint end (212) to completely block the inside from the outside, thereby blocking the inflow of external air.

The present invention relates to maintaining the internal humidity of a container at or below a certain level by configuring the container floor as a bent-shaped steel base to block external air from entering.

In conventional containers, the floor was made of wood, which allowed external air to seep through, making it difficult to control the humidity of the internal space. To fundamentally block the inflow of external air through the floor, the present invention utilizes a steel base made of steel material for the container floor.

Looking at the present invention in detail with reference to the drawings, first, the present invention features a door sealing member (300) made of dual rubber, which is provided between the rear frame (170) provided at the rear of the container body and the container door (180) to seal the inside of the container when the door is closed. The door sealing member is coupled to the edge of the door using bolts (to be described below).

The door sealing member includes: a first sealing member (310) mounted on the door and made of a rubber material; a second sealing member (320) made of a rubber material softer than the first sealing member, formed in a semi-circular shape protruding upward from an upper surface of the first sealing member, and configured to contact the rear frame; and an L-shaped retainer (350) attached to the upper surface of the first sealing member.

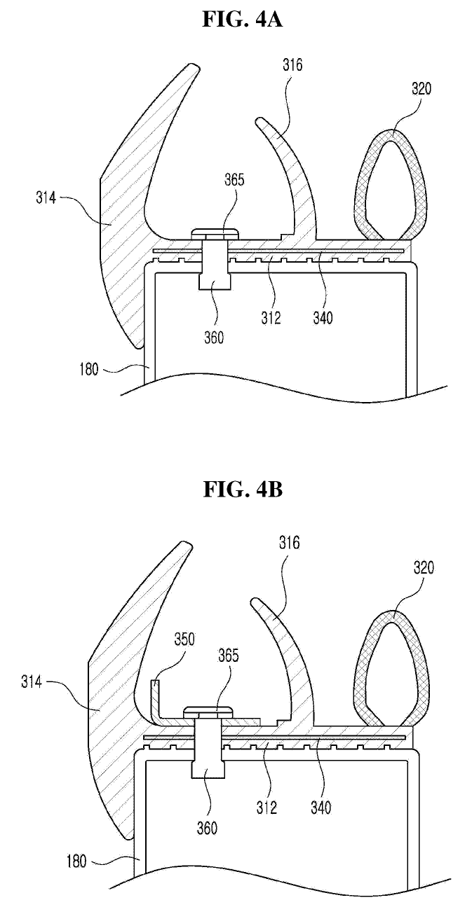

However, the L-shaped retainer (350) may not be provided. In the sealing member shown in FIG. 3A, a shape without the retainer is illustrated, and in the door sealing member shown in FIG. 3B, a shape including the retainer is illustrated. As such, the retainer may be optionally provided, and the same applies to FIGS. 4A and 4B.

In addition, the door sealing member (300) is manufactured using two rubber materials having different properties, provided in a form in which they are integrally coupled to each other. That is, the first sealing member (310), made of a relatively hard rubber material, and the second sealing member (320), made of a relatively soft rubber material, are integrally coupled to each other. The door sealing member may be coupled to the door by a coupling means such as bolts or an adhesive. Furthermore, during the process of closing the door, the first sealing member (310), which is the relatively hard rubber material, is configured not to directly contact the rear frame (170), while the second sealing member (320), which is the relatively soft rubber material, is configured to directly contact the rear frame (170).

The first sealing member (310) comprises: a 1-1 member (312) coupled to one surface of the door in a lateral direction; a 1-2 member (314) formed in a vertical direction at one lateral end of the 1-1 member; and a 1-3 member (316) formed to protrude vertically upward from the center of the upper surface of the 1-1 member.

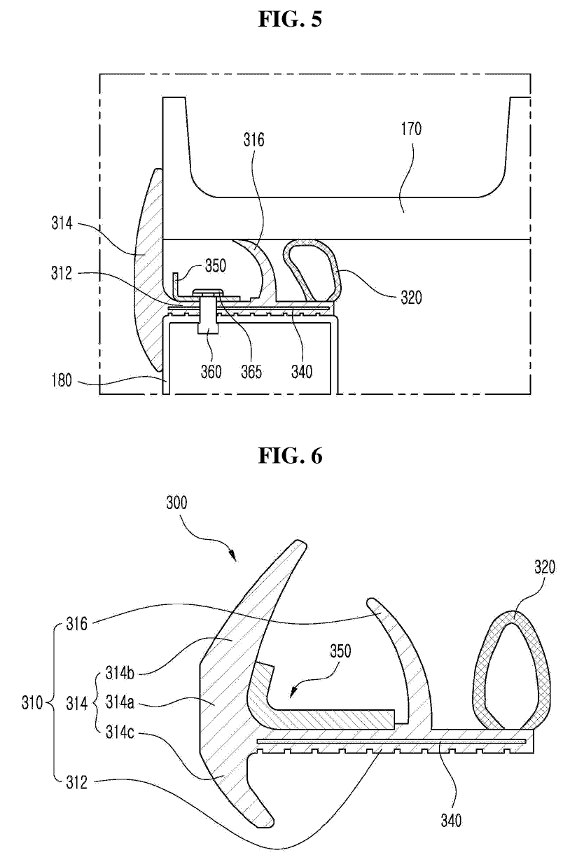

The door sealing member (300) illustrated in FIGS. 4A, 4B, and 5 is mounted on the peripheral portion of the container door (180) using bolts, specifically showing a state in which it is mounted on the upper peripheral portion of the container door. In addition, directions such as "lateral direction," "vertical direction," "left side," and "right side" mentioned in the following description do not mean absolute directions, but are merely expressions for the convenience of description based on the drawings (i.e., these expressions are based on the state in which the door sealing member is mounted on the upper edge of the container door).

The retainer (350) comprises: a horizontal member (352) positioned on the upper surface of the 1-1 member; and a vertical member (354) formed in a vertical direction at one end of the horizontal member. The retainer (350) may be made of metal or plastic, but is preferably made of a metal material to have a structure capable of firmly supporting the 1-2 member (314) from the inside.

In addition, the device further includes a core member (340) provided along a lateral direction inside the 1-1 member (312) to increase rigidity, and is firmly coupled using bolts and nuts. That is, a bolt (360) and a nut (365) are used to integrally fasten the horizontal member of the retainer, the 1-1 member, and the core member, thereby firmly coupling the first sealing member to the door.

An outer surface of the 1-2 member (314) may be configured to include: a vertical surface (314a) formed vertically at a central portion; an upper curved surface (314b) formed above the vertical surface; and a lower curved surface (314c) formed below the vertical surface.

As described above, the present invention includes a core member (340) provided along a lateral longitudinal direction inside the 1-1 member (312) and a retainer (350) on an upper surface of the 1-1 member (312) for the rigidity of the door sealing member, and these may be fastened to the container door by passing through them using bolts. In the structure of the present invention, during a process of closing the door, a side surface of the rear frame comes into contact with an inner vertical surface of the 1-2 member (314), and a lower surface of the rear frame comes into contact with upper ends of the 1-3 member (316) and the second sealing member (320), thereby maintaining the inside of the container in an airtight state.

By utilizing this structure, the present invention achieves the effects of enhancing the sealing function and increasing the durability of the rubber door sealing member when repetitive door opening and closing operations occur between the container door and the rear frame.

Specifically, due to the dual-rubber structure of the sealing member of the present invention, which comprises hard and soft rubber, the relatively hard first sealing member is primarily and firmly coupled to the door to protect the relatively soft second sealing member. Even if partial damage occurs on the surface of the door unit during repeated opening and closing processes, the structure of the second sealing member allows for surface contact, thereby very effectively performing the internal sealing function of the container despite paint damage or partial surface damage to the door unit.

The present invention processes the container floor with a steel base and applies an airtight structure to the door unit, thereby completely sealing the inside of the container and blocking the inflow of moisture caused by external air ingress, which allows the internal humidity of the container to be maintained at or below a required level. In particular, the present invention is a non-powered dehumidifying container capable of dehumidification without using a power source for dehumidification, such as a dehumidifying device. Dehumidifying agents may be appropriately disposed at necessary positions within the container for dehumidification.

By implementing the container door as an airtight door structure, the present invention blocks the inflow of external air into the container through the door, thereby enabling the control of the internal humidity of the container to be maintained at or below a predetermined level.

1. A container having a door sealing member, comprising:
a rear frame provided at a rear of a container body;
a door mounted on the rear of the container to open and close an inside and an outside thereof; and
a door sealing member (300) provided between the rear frame and the door to seal the inside of the container,
wherein the door sealing member comprises:
a first sealing member (310) mounted on the door and made of a rubber material; and
a second sealing member (320) made of a rubber material softer than the first sealing member, formed in a semi-circular shape protruding upward from an upper surface of the first sealing member, and configured to contact the rear frame.

2. The container of claim 1, wherein the first sealing member (310) comprises:
a 1-1 member (312) coupled to one surface of the door in a lateral direction;
a 1-2 member (314) formed in a vertical direction at one lateral end of the 1-1 member; and
a 1-3 member (316) formed to protrude vertically upward from a center of the upper surface of the 1-1 member.

3. The container of claim 2, further comprising:
an L-shaped retainer (350) attached to the upper surface of the first sealing member.

4. The container of claim 3, wherein the retainer (350) comprises a horizontal member (352) positioned on the upper surface of the 1-1 member and a vertical member (354) formed in a vertical direction at one end of the horizontal member, the container further comprising:
a core member (340) provided along a lateral direction inside the 1-1 member (312);
a bolt (360) passing through and fastening the horizontal member of the retainer, the 1-1 member, and the core member to couple the first sealing member to the door; and
a nut (365) fastened to an upper end of the bolt.

5. The container of claim 4, wherein, during a process of closing the door,
a side surface of the rear frame comes into contact with an inner surface of the 1-2 member (314), and
a lower surface of the rear frame comes into contact with upper ends of the 1-3 member (316) and the second sealing member (320) to maintain the inside of the container in an airtight state.
